(19) United States
(12) Patent Application Publication
(10) Pub. No.: US 2012/0023740 A1
(43) Pub. Date: Feb. 2, 2012

(54) APPLICATOR DEVICE FOR ATTACHING METAL TERMINALS ONTO ELECTRICAL CABLES BY CONTROLLED CRIMPING ONTO THE CONDUCTOR OF SAID CABLES AND CRIMPING UNIT EQUIPPED WITH THIS DEVICE

(75) Inventor: Luigi Aluffo, Fubine-Alessandria (IT)

(73) Assignee: MECAL S.R.L., Fubine-Alessandria (IT)

(21) Appl. No.: 13/138,084

(22) PCT Filed: Jan. 13, 2010
(86) PCT No.: PCT/EP2010/000194

§ 371 Date: Sep. 8, 2011

(30) Foreign Application Priority Data
Jan. 20, 2009 (IT) MI2009A 000048

(51) Int. Cl. H01R 43/00

(52) U.S. Cl. 29/747

(57) ABSTRACT

An applicator device for attaching metal terminals onto electrical cables, of the type comprising a crimping assembly (4) equipped with a support (11) for the knife (6) for crimping the insulation of the electrical cable and for a blade (7) for cutting and detaching the metal terminal from the respective carrier strip, and equipped furthermore with a knife (5) for crimping the conductor of the same electrical cable, a load cell (10) being provided for detecting the crimping load on said terminal. The device of the invention comprises in particular means for the independent or selective transmission of the reaction F3 to the crimping thrust F1 onto the said knife (5) for the conductor of the electrical cable, these means consisting of a block (8) and a shaft (9) for transmitting the same reaction F3 onto the said load cell (10). In relation to the known devices, the device realised according to the present invention offers the advantage of selectively detecting the action of the press on the knife which acts on the conductor part of the electrical cable. In this way it is guaranteed that this is actually the action desired, thus isolating it from being influenced by the effect of the press itself on the remaining movable or active parts of the device (in particular the knife for the insulation and the blade for detaching the terminal from the strip).

The present invention concerns an applicator device for attaching metal terminals onto electrical cables, equipped with systems for controlled crimping of the terminal onto the conductor part of these cables. The invention also extends to the crimping unit equipped with this device.

The field of the invention is that of devices used for attaching metal terminals onto electrical cables. An example of these applicator devices is provided by Italian patent application no. TO2001A000022, filed in the name of the same Applicant.

With the object of ensuring that the pressure exerted on the crimping zone of the terminal onto the cable is as per design, the practice is known of providing load cell systems which sense the action of the press on the assembly of the knives (for crimping respectively the insulation and the conductor of the electrical cable) and of the blade for cutting and detaching the terminal from the respective carrier strip.

This type of known solution however has the disadvantage of not allowing the possibility of selecting monitoring of the specific action performed by the press on the conductor part of the electrical cable, which is the critical part for the functionality of the connection and the overall quality of the crimping. In consequence it is possible that, for a given total pressure exerted by the press on the terminal, the specific action on the conductor part of the electrical cable will be insufficient to obtain the correct state of crimping. Consequently the product obtained could undergo incorrect crimping which, in the most serious cases, could even mean that the connection at the point of contact between the cable and the terminal fails to achieve electrical conductivity.

The principal object of the present invention consists in providing an applicator device which enables the desired action of the press on the conductor part of the electrical cable to be guaranteed, so as to ensure the achievement of the perfect state of crimping onto the latter.

These and other objects are achieved with the device and the crimping unit of respectively claims 1 and 7. Some preferred ways of embodying the invention are contained in the remaining claims.

In relation to the known devices, the device realised according to the present invention offers the advantage of selectively detecting the action of the press on the knife which acts on the conductor part of the electrical cable. In this way it is guaranteed that this is actually the action desired, thus isolating it from being influenced by the effect of the press itself on the remaining movable or active parts of the device (in particular the knife for the insulation and the blade for detaching the terminal from the strip).

These and other objects, advantages and characteristics are apparent from the description which follows of a preferred embodiment of the device and the crimping unit of the present invention, illustrated by way of non-limiting example in the attached drawings, where:

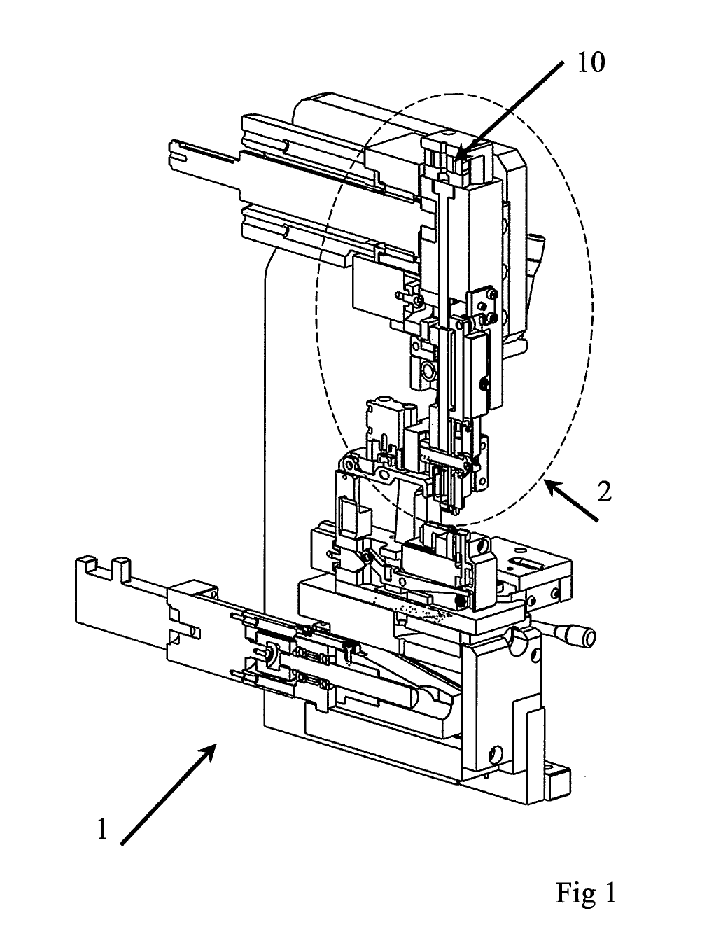

FIG. 1 illustrates in perspective a crimping press equipped with the device of the invention, represented in section along the longitudinal axis;

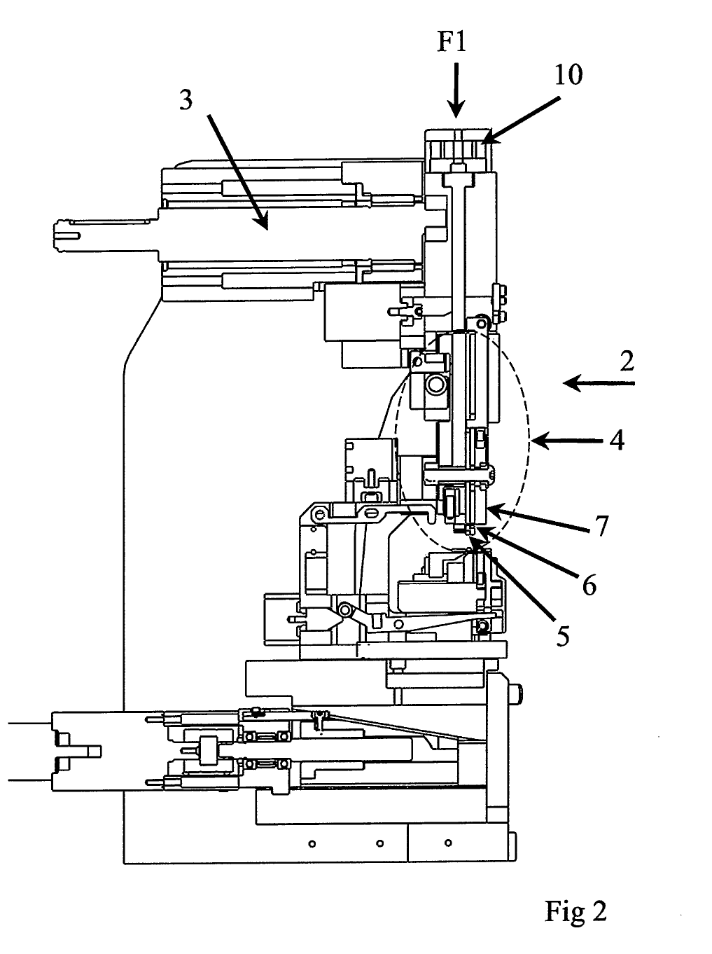

FIG. 2 illustrates in a side view the press shown in FIG. 1;

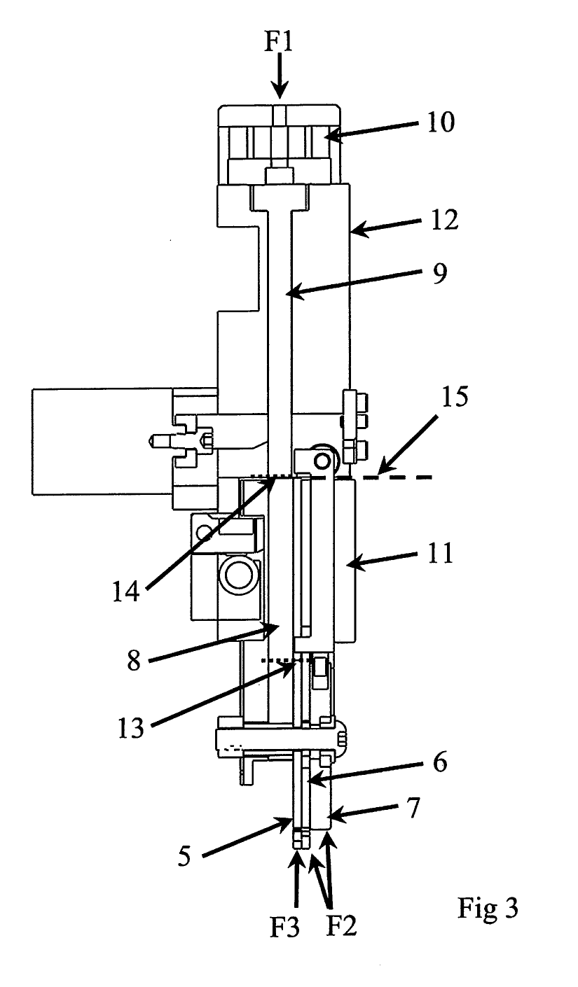

FIG. 3 illustrates a section view of the enlarged detail of the device fitted to the press shown in FIG. 2.

In FIG. 1, reference no. 1 indicates the unit (in the example illustrated, a press) for crimping metal terminals onto electrical cables, while reference no. 2 distinguishes the applicator device of the invention.

The press 1 is in particular equipped with an eccentric shaft 3, suitable for exerting a thrust F1 on the crimping assembly 4 of the device 2, said assembly comprising the knife 5 for crimping the conductor part of the cable, the knife 6 for crimping the insulation part, and the blade 7 for detaching the terminal from the respective carrier strip.

As is better illustrated in FIG. 3, the crimping device 2 is equipped with a load cell 10 which receives the reaction F3 to the force F1 exerted by the press 1 on the knife 5 which acts on the conductor part of the electrical cable, respectively through a counterthrust shaft 9 and a block 8. In particular this reaction F3 is transmitted, by shaft 9 to block 8, through the common support surface 14 and, by block 8 to knife 5, by means of the common support surface 13.

For its part, the remaining part of the support 11 for the crimping assembly 4 acts respectively on the knife 6 for the insulation and on the above-mentioned blade 7, the latter receiving the movement of the slide 12 activated by the eccentric shaft 3. This support 11 bears in its turn on the same slide 12, in the area of contact surfaces 15 laterally located with respect to the above-mentioned contact surface 14 of block 8 with shaft 9 of the press.

To explain it another way:
the reaction F3 to the thrust force F1 exerted by the press 1 on knife 5 is discharged onto load cell 10 by means of block 8 and shaft 9, through the respective contact surfaces 13 and 14;
the reaction F2 to the same force F1 on knife 6 and blade 7, on the other hand, is discharged onto slide 12 by means of crimping support 11, through contact surfaces 15A, 15B.

From the description given above, it is clear that there are two parts of crimping device 2 which, independently or selectively, receive reactions F2 and F3 to thrust F1 exerted by press 1, in particular:
a first part, formed by support 11 which acts on knife 6 for the insulation and on blade 7 for cutting the terminal; and
a second part, defined by load cell 10, counterthrust shaft 9, counterthrust block 8 and knife 5, which specifically monitors the crimping onto the conductor of the electrical cable.

Thanks to this selective distribution of loads, which distinguishes between knife 5 (for crimping onto the conductor of the electrical cable) and knife 6 and blade 7, it becomes possible to specifically monitor the action of the press on the above-mentioned knife 5. In this way errors are avoided resulting from reaching a design pressure which however does not distinguish between action on knife 5 for the conductor (critical for the quality of the crimping) and action on the remaining parts of the support 11 for the crimping assembly 4.

Although the invention has been described and illustrated so far with reference to the press shown in FIG. 1, it is to be understood that the said invention can equally have application in the case of a mini-applicator, for example as described in Italian patent application no. TO2001A000022, filed in the name of the same Applicant, particularly of the type which comprises a group of adjuster rings for regulating the crimping position of the above-mentioned knives 5 and 6.

1. Applicator device for metal terminals onto electrical cables, of the type comprising a crimping assembly (4) equipped with a support (11) for the knife (6) for crimping the insulation of the electrical cable and for a blade (7) for cutting and detaching the metal terminal from the respective carrier strip, and equipped furthermore with a knife (5) for crimping the conductor of the same electrical cable, a load cell (10) being provided for detecting the crimping load on said terminal, characterised by comprising means for the independent or selective transmission of the reaction F3 to the crimping thrust F1 on the said knife (5) for the conductor of the electrical cable.

2. Device according to claim 1, characterised in that the said means for the selective transmission of the above-mentioned reaction F3 onto the knife (5) for the conductor of the electrical cable comprise a block (8) and a shaft (9) for transmitting the same reaction F3 onto the said load cell (10).

3. Device according to claim 2, characterised in that the said reaction F3 is transmitted, from the knife (5) to the block (8), through a respective contact surface (13) and, from the block (8) to the shaft (9), through a respective contact surface (14).

4. Device according to claim 2, characterised by providing furthermore means of selective transmission of the reaction F2 to the crimping thrust F1 onto the said knife (6) for the insulation and onto the above-mentioned blade (7).

5. Device according to claim 4, characterised in that the said means for selective transmission of the above-mentioned reaction force F2 comprise a crimping support (11) suitable for discharging this force F2 onto a slide (12) through a common bearing surface (15).

6. Device according to claim 1, characterised by consisting of a mini-applicator device, of the type equipped with adjuster rings for regulating the crimping position of said knives (5,6).

7. Unit for crimping metal terminals onto electrical cables, characterised by being equipped with the device according to claim 1.

8. Unit according to claim 7, characterised by consisting of a press (1) and by comprising an eccentric shaft (3) for activating the said slide (12) for the transmission of a thrust F1 onto the said crimping assembly (4).
